(19) United States
(12) Patent Application Publication
(10) Pub. No.: US 2008/0196599 A1
(43) Pub. Date: Aug. 21, 2008

(54) COOKING AND DRAINING APPARATUS FOR FOOD CONTAINED IN A LIQUID, COMPRISING EVAPORATION PERFORATIONS AND DRAINING PERFORMATIONS

(76) Inventor: Amaury Bhagat, Paris (FR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/033,621

(22) Filed: Feb. 19, 2008

(30) Foreign Application Priority Data
Feb. 19, 2007 (FR) 0753332

(51) Int. Cl. A47J 27/00

(52) U.S. Cl. 99/444

(57) ABSTRACT

The invention relates to a cooking and straining device (1) for food contained in a liquid, of the type including a vessel (2) provided with a removable lid (3) which has, on its bottom side, a skirt (8) comprising two sets of perforations, the first set of perforations consisting of orifices for releasing the steam formed during the cooking process, and the second set of perforations consisting of straining orifices.

The invention relates to a device designed for cooking and straining food contained in a liquid.

The expression “contained in a liquid” is taken to refer to the liquid in which the food is cooked, or the liquid that may be produced when cooking the food, such as grease.

A large number of dishes require the food to be cooked in a cooking liquid and then strained. Examples include pasta, rice and similar products, which are cooked in water and then strained at the end of the cooking process. It may also be necessary, while cooking certain types of food, to reduce the amount of liquid in which they are cooking, or even remove of the grease or juice extracted from them as they cook.

Conventionally, food is cooked in a liquid in a vessel, and it is strained using another utensil (colander or similar). However, this method has disadvantages. First of all, it requires simultaneously using two utensils: the vessel in which the food is cooked and the colander into which the contents of the vessel are poured for straining. This operation requires a certain amount of strength and dexterity. In addition, it is dangerous in that the vessel to be handled is generally extremely hot.

In order to solve some of these disadvantages, numerous devices combining a cooking vessel and a straining utensil have been designed.

In particular, American U.S. Pat. No. 5,653,881 describes an utensil combining the characteristics of a cooking vessel with those of a strainer. In one specific embodiment, the utensil comprises a vessel with a spout and a lid. The lid comprises a downwardly extending skirt which comprises a straining section.

The lid also has inverted L-shaped slots respectively cooperating with knobs formed on the inner wall of the vessel. The slots and knobs are positioned so that, when a user turns the lid into the straining position, the knobs engage the horizontal portions of the slots, thereby securing the lid to the vessel.

When using the utensil, the lid is placed on the vessel so that the straining section is not in contact with the spout. In this position (closed position), the skirt of the lid seals the opening created by the spout. Once the cooking is done and the user wishes to strain the cooked food, he or she rotates the lid to align the strainer section of the skirt with the spout (straining position). In this position, the knobs of the vessel are engaged in the horizontal portion of the slots of the skirt of the lid, and the lid is secured to the vessel. The user can then handle the vessel with both hands without the risk of the lid coming off the vessel.

This type of utensil is suitable for braising, and possibly for pressure cooking, when the vessel is hermetically sealed. On the other hand, it is not suitable for cooking partially covered food, or even for cooking that requires partial evaporation of the water during the cooking process.

The invention aims, in particular, to solve the disadvantages of the prior art by providing an utensil for cooking food in a liquid that allows the water formed during the cooking process to evaporate and the food to be strained.

For this purpose, according to a first aspect, the invention relates to a device for cooking and straining food contained in a liquid, of the type including:

a vessel equipped with a removable lid, said vessel including at least one wall comprising at least one orifice for pouring out the liquid contained in said vessel, said lid having, on its bottom side, a skirt comprising perforations, said skirt being arranged so as to be secured against the wall of the vessel when the lid is on the vessel, and

means for positioning the lid on the vessel, said lid being capable of moving from a cooking position to a straining position, and vice-versa, by rotation about a vertical axis of the lid when the latter is positioned on the vessel.

The cooking and straining device is notable in that the skirt comprises two sets of perforations arranged so that, when the lid is positioned on the vessel in cooking position, one of the sets of perforations is placed before the pouring orifice and, when the lid is positioned on the vessel in straining position, the other set of perforations is placed before the pouring orifice, the first set of perforations consisting of orifices for releasing the steam formed during the cooking process and the second set of perforations consisting of straining orifices.

The two sets of perforations are advantageously arranged separated from one another by a pitch of less than 90 degrees, preferably less than 45 degrees. Such an arrangement therefore allows, by a slight rotation of the lid on the vessel, a quick change between the cooking position and the straining position and vice-versa.

The means for positioning the lid on the vessel advantageously comprise at least one notch formed in the skirt of the lid, said notch being designed to cooperate with a projection located on the wall of the vessel.

More particularly, the notch comprises two branches extending in opposite directions, the closed end of each branch defining, in association with the projection of the vessel, one of the two positions of the lid on the vessel. Also, according to a specific configuration of the invention, the notch has a T shape, each of the ends of the top branch of the T shape defining, in association with the projection of the vessel, one of the two positions of the lid on the vessel.

Advantageously, the positioning means comprise means for marking the position of the lid on the vessel.

It can also be provided for the skirt of the lid to have two areas respectively equipped with one of the sets of perforations, said areas being separated by a non-perforated area, one of the perforated areas having a lower density of perforations than the other area. This configuration has the advantage of defining two distinct positions of the lid on the vessel, one of the positions being strictly associated with releasing the steam, the other position being strictly associated with straining the food. This configuration therefore requires less precision when positioning the lid on the vessel.

Further objectives and advantages of the invention will become apparent from the following description made in reference to the appended drawings, wherein:

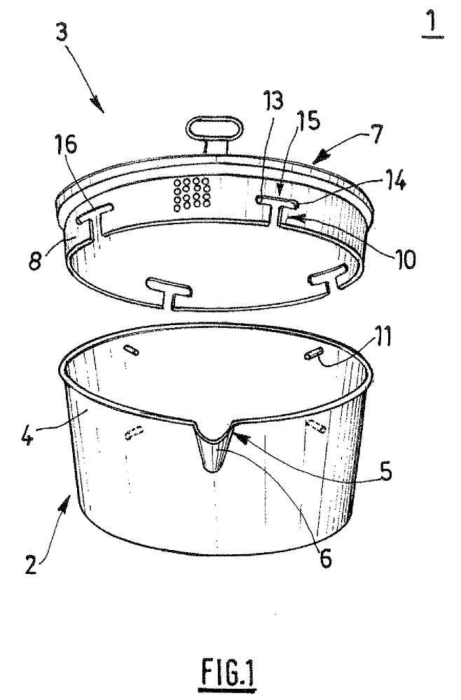

FIG. 1 shows an exploded perspective view of a cooking and straining device according to a first embodiment of the invention; and

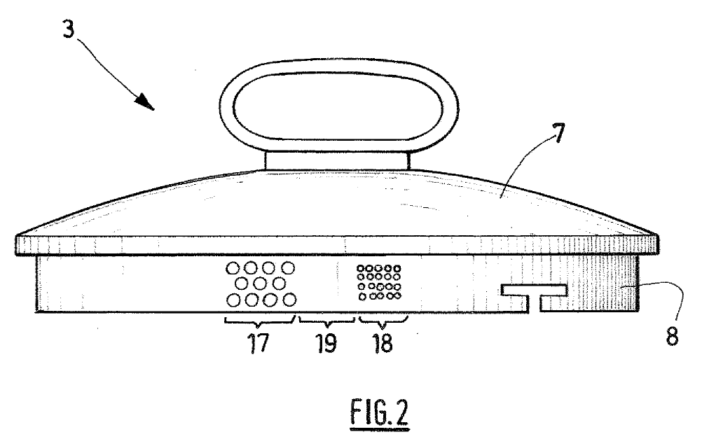

FIG. 2 shows a front view of a lid of the cooking and straining device according to a second embodiment of the invention.

In relation to FIGS. 1 and 2, a device 1 is described which combines the functions of cooking and straining food contained in a liquid.

The device 1 consists of a cylindrical vessel 2 equipped with a removable lid 3.

The vessel 2 comprises a wall 4 provided with a pouring orifice 5 designed for pouring the liquid in which the food was cooked out of the vessel. In the depicted example, the pouring orifice 5 comprises a spout 6.

In order to allow easier handling of the device 1, in particular during the straining operation, the vessel 2 comprises handling means (not shown). The handling means can advantageously consist of two diametrically opposed handles, located on the outer surface of the wall of the vessel, and arranged on the outer surface of the wall of the vessel, in a longitudinal plane located at 45 degrees from the spout.

The lid 3 has a covering part 7 designed to cover the opening of the vessel 2.

The covering part 7 is provided, on its bottom side, with a skirt 8 arranged to be in close contact with the inner surface of the wall of the vessel 2 when the opening of the vessel 2 is closed by the lid 3, while allowing a rotating movement of the skirt 8 according to a vertical axis. Furthermore, the skirt 8 is sized to cover the opening of the spout 6, at least partially as can be seen in the section describing FIG. 2.

The skirt 8 also comprises a delimited area comprising a plurality of perforations 9. As will be seen below, a part of these perforations will form perforations allowing the release of the steam formed when cooking the food, the remaining part, possibly connected with the steam-release perforations, forming perforations allowing the food to be strained, i.e. pouring the cooking liquid out of the vessel.

Cooking liquid is taken to refer to the liquid in which the food is cooked, or the liquid that may be produced when cooking the food, such as grease.

The cooking and straining device 1 comprises means allowing the lid 3 to be positioned on the vessel 2 depending on whether the user wants to cook the food or strain it.

More specifically, this involves positioning either the steam-release perforations or the straining perforations opposite the opening of the spout according to whether the food is to be cooked or strained respectively. The lid 3 must be placed on the vessel in cooking position in the former case and in the straining position in the latter case.

The means for positioning the lid 3 on the vessel 2 comprise, on the one hand, at least one notch 10 formed in the skirt 8 of the lid 3, and at least one projection 11 formed on the inner surface of the wall of the vessel 2, the notch 10 being arranged to accommodate the projection 11.

FIG. 1 shows a cooking and straining device 1 including four notches and four associated projections. It is evident that this is one particular embodiment of the invention, and that the number of notches and projections is not limited to that shown. In particular, it is possible to provide a single notch with its corresponding projection.

Each notch 10 comprises two branches extending in opposite directions, the closed end of each branch defining, in association with the projection 11 of the vessel capable of accommodating said notch 10, one of the two positions of the lid on the vessel. According to an advantageous configuration of the invention shown in FIG. 1, the notches are T-shaped.

Each of the ends 13, 14 of the top branch 15 of the T shape defines, in association with the projection 11 of the vessel 2 capable of accommodating a notch 10, the cooking position or the straining position.

Thus configured, the positioning means consisting of at least one notch 10 and at least one projection 11 form means for marking the position of the lid 3 on the vessel 2 in a given position (cooking position or straining position).

The operating principle is as follows. The lid 3 is positioned above the opening of the vessel 2, the notches 10 of the lid 3 being arranged opposite the projections 11 of the vessel. The lid 3 is then pushed vertically towards the bottom of the vessel 2, the skirt 8 entering the vessel 2, in close contact with the inner surface of the vessel 2. The notches 10 engage with the corresponding projections 11 and come to a stop in a stopping area 16 in the top branch 15 of the T shape. The lid 3 is then subjected to a rotating movement around the vertical axis in clockwise direction, until the notches 10 are positioned against the end 14 of the top branch 15 of the T shape. The opening of the spout is then covered by an area of the skirt 8 of the lid 3 comprising, on one part only, perforations defining steam-release perforations. The lid 3 is then in cooking position. The lid 3 is moved into the straining position by rotating the lid in anticlockwise direction until the notches 10 are positioned against the end 13 of the top branch 15 of the T shape. The opening of the spout is then covered by a perforated area of the skirt 8 of the lid 3, the perforations corresponding to the straining perforations.

Thus, in cooking position, the density of the perforations positioned opposite the opening of the spout is less than that of the perforations positioned opposite the opening of the spout when the lid is in straining position.

According to one specific configuration of the invention, it can be provided for the steam-release perforations and the straining perforations to have different configurations (sizes, shapes, etc.).

FIG. 1 shows a lid 3 with a skirt 8 including a single area of perforations comprising, on the one hand, the steam-release perforations and, on the other hand, the straining perforations. According to another configuration of the invention, it can be provided for the skirt 8 of the lid to have two areas 17, 18 with perforations, said areas 17, 18 being separated from one another by a non-perforated area 19 (cf. FIG. 2).

This configuration has the advantage of defining two distinct positions of the lid 3 on the vessel 2, one of the positions being strictly associated with releasing the steam, the other position being strictly associated with straining the food. No precision is therefore required when positioning the lid on the vessel.

It has the further advantage of defining an additional position of the lid 3 on the vessel, corresponding to a position in which evaporation is reduced. In this configuration, in fact, the skirt 8 of the lid 3 is configured so as not to completely block the opening of the spout 6, leaving only a small space free between the vessel 2 and the lid. The lid 3 is in this additional position when the notches 10 are resting against the stopping area. Thus, when the notches 10 are positioned in the projections 11, in the stopping area, the non-perforated area 19 is positioned in front of the opening of the spout, partially blocking it.

As above, the perforated areas can have different perforation densities and perforation configurations.

The separation between the ends of the top branch is determined according to the distance separating the two perforated areas 17, 18. In order to allow quick and easy switching between the two perforated areas 17, 18, it is advantageous to arrange them on the skirt 8 relatively close to one another. More specifically, it is advantageous to arrange the two sets of perforations separated from one another by a pitch of less than 90 degrees, preferably less than 45 degrees. Thus, considering the “proximity” of the sets of perforations, only a slight movement is required to change the lid between its cooking position and its straining position and vice-versa (it can be described as a “localised” movement).

The hermetic seal can be improved by providing a seal arranged under the covering part 7, along the joint between the covering part 7 and the skirt 8.

The invention is described above as an example. It is understood that those skilled in the art are capable of making different variations of the invention without departing from the invention.

1. Device for cooking and straining (1) food contained in a liquid, of the type comprising a vessel (2) provided with a removable lid (3), said vessel (2) including at least one wall (4) comprising at least one orifice (5) for pouring out the liquid contained in said vessel, said lid (3) having, on its bottom side, a skirt (8) comprising perforations (9), said skirt (8) being arranged so as to be secured against the wall (4) of the vessel (2) when said vessel (2) has its lid (3) on, the cooking and straining device (1) also comprising means for positioning the lid on the vessel (2), said lid (3) being capable of changing from a cooking position to a straining position, and vice-versa, by rotation around a vertical axis of the lid (3) when it is positioned on the vessel (2), the cooking and straining device (1) being characterised in the skirt (8) comprises two sets of perforations arranged so that, when the lid (3) is positioned on the vessel (2) in cooking position, one of the sets of perforations is placed before the pouring orifice (5) and, when the lid (3) is positioned on the vessel (2) in straining position, the other set of perforations is placed before the pouring orifice (5), the first set of perforations consisting of orfices for releasing the stream formed during the cooking process, and the second set of perforations consisting of straining orfices.

2-11. (canceled)
